(19) United States
(12) Patent Application Publication
(10) Pub. No.: US 2023/0267671 A1
(43) Pub. Date: Aug. 24, 2023

(54) APPARATUS AND METHOD FOR SYNCHRONIZATION WITH VIRTUAL AVATAR, AND SYSTEM FOR SYNCHRONIZATION WITH VIRTUAL AVATAR

(71) Applicant: ELECTRONICS AND TELECOMMUNICATIONS RESEARCH INSTITUTE, Daejeon (KR)

(72) Inventors: Dae-Hwan KIM, Sejong-si (KR); Ki-Hong KIM, Sejong-si (KR); Yong-Wan KIM, Daejeon (KR); Jin-Sung CHOI, Daejeon (KR)

(21) Appl. No.: 18/102,160

(22) Filed: Jan. 27, 2023

(30) Foreign Application Priority Data
Feb. 18, 2022 (KR) 10-2022-0021458

(51) Int. Cl. G06T 13/40; G06T 7/11; G06T 7/50; G06T 7/70; G06V 10/25; G06V 10/764

(52) U.S. Cl. CPC G06T 13/40; G06T 7/11; G06T 7/50; G06T 7/70; G06V 10/25; G06V 10/764; G06V 2201/07; G06T 2207/20044; G06T 2207/20084; G06T 2207/30196

(57) ABSTRACT

Disclosed herein is an apparatus for synchronization with a virtual avatar. The apparatus may include a body part detection unit for detecting a human body part in an input 2D image, a visible body part estimation unit for estimating the shape and pose of a visible body part based on the detected body part, an invisible body part generation unit for generating a shape and pose of an invisible body part based on the body part and the shape and pose thereof, a body estimation unit for estimating a full-body shape and pose based on the shape and pose of the visible body part and the shape and pose of the invisible body part, and a virtual avatar synchronization unit for encoding and transmitting the estimated full-body shape and pose information for synchronization with a virtual avatar modeled in advance in a server.

### CROSS REFERENCE TO RELATED APPLICATION

This application claims the benefit of Korean Patent Application No. 10-2022-0021458, filed Feb. 18, 2022, which is hereby incorporated by reference in its entirety into this application.

### BACKGROUND OF THE INVENTION

### 1. Technical Field

The present disclosure relates to a virtual avatar synchronization apparatus and method for synchronizing a user himself/herself with a virtual avatar in real time.

### 2. Description of Related Art

Recently, with the advent of the non-face-to-face era, studies on an interaction method for synchronization with an avatar for naturally representing the appearance and motion of a user in a virtual world, such as a virtual-reality or metaverse environment, have been conducted.

Particularly, in a virtual performance, a teleconference, a virtual-reality game, and the like, modeling an avatar of a participant and reflecting motions of the participant are essential to improve a sense of reality and a sense of coexistence.

Meanwhile, a Head-Mounted Display (HMD) is regarded as being essential for participation in virtual reality, but it has low device accessibility because it is expensive and uncomfortable to use. Therefore, a lot of time is needed for such HMD devices to become popular.

Accordingly, a method for enabling a user to represent his/her own avatar and participate in a virtual world based on popular devices, such as TVs, PCs, tablet PCs, smartphones, and the like, is required.

### SUMMARY OF THE INVENTION

An object of the present disclosure is to provide an apparatus and method for synchronization with a virtual avatar and a system for synchronization with a virtual avatar in order to automatically estimate and generate a motion of a user using popular devices and synchronize the same with a virtual avatar.

In order to accomplish the above object, an apparatus for synchronization with a virtual avatar according to the present disclosure may include a body part detection unit for detecting a body part of a human in an input 2D image, a visible body part estimation unit for estimating a shape and pose of a visible body part based on the detected body part, an invisible body part generation unit for generating a shape and pose of an invisible body part based on the body part and the shape and pose of the body part, a body estimation unit for estimating a full-body shape and pose based on the shape and pose of the visible body part and the shape and pose of the invisible body part, and a virtual avatar synchronization unit for encoding and transmitting the estimated full-body shape and pose for synchronization with a virtual avatar that is modeled in advance in a server.

The apparatus may further include an image collection unit for collecting the 2D image.

The body part detection unit may include a body part detection module for detecting a region in which a body is located in the 2D image as a boxed region and a body part classification module for classifying a body part in the boxed region.

The body part detection module may predict joint key points of a main part using a deep neural network and detect the boxed region based on the joint key points.

The body part classification module may divide the boxed region into multiple regions and classify each of the multiple regions as a body part using a convolutional neural network.

The visible body part estimation unit may include a joint position detection module for detecting a joint position of the detected body part and a visible body part estimation module for estimating a shape and pose of a 3D body part based on the detected joint position.

The invisible body part generation unit may include an invisible body part estimation module for estimating the shape and pose of the invisible body part based on the shape and the pose of the visible body part and a body part generation module for generating a shape and pose of an invisible 3D body part based on the estimated shape and pose of the invisible body part.

The body estimation unit may include a normalization module for normalizing size and orientation information pertaining to the shape and pose of the visible body part and size and orientation information pertaining to the shape and pose of the invisible body part and a full-body estimation module for estimating a human full-body shape and pose by fusing the normalized shape and pose of the visible body part and the normalized shape and pose of the invisible body part.

The server may include a decoding module for decoding the encoded full-body shape and pose and a mapping module for mapping the decoded full-body shape and pose to the virtual avatar.

Also, a method for synchronization with a virtual avatar according to an embodiment may include collecting a 2D image, detecting a body part of a human in the input 2D image, estimating a shape and pose of a visible body part based on the detected body part, generating a shape and pose of an invisible body part based on the body part and the shape and pose of the body part, estimating a full-body shape and pose based on the shape and pose of the visible body part and the shape and pose of the invisible body part, and encoding and transmitting the estimated full-body shape and pose for synchronization with an avatar modeled in advance in a server.

Detecting the body part may include detecting a region in which a body is located in the 2D image as a boxed region and classifying a body part in the boxed region.

Detecting the region as the boxed region may comprise predicting joint key points of a main part using a deep neural network and detecting the boxed region based on the joint key points.

Classifying the body part may comprise dividing the boxed region into multiple regions and classifying each of the multiple regions as a body part using a convolutional neural network.

Estimating the shape and pose of the visible body part may include detecting a joint position of the detected body part of the human and estimating a shape and pose of a 3D body part based on the detected joint position.

Generating the shape and pose of the invisible body part may include estimating the shape and pose of the invisible body part based on the shape and pose of the body part and generating a shape and pose of an invisible 3D body part based on the estimated shape and pose of the invisible body part.

Estimating the full-body shape and pose may include normalizing size and orientation information pertaining to the shape and pose of the visible body part and size and orientation information pertaining to the shape and pose of the invisible body part and estimating a human full-body shape and pose by fusing the normalized shape and pose of the visible body part and the normalized shape and pose of the invisible body part.

The server may decode the encoded full-body shape and pose and map the decoded full-body shape and pose to the virtual avatar.

Also, a system for synchronization with a virtual avatar according to an embodiment may include a body part detection unit for detecting a body part of a human in an input 2D image, a visible body part estimation unit for estimating a shape and pose of a visible body part based on the detected body part, an invisible body part generation unit for generating a shape and pose of an invisible body part based on the body part and the shape and pose of the body part, a body estimation unit for estimating a full-body shape and pose based on the shape and pose of the visible body part and the shape and pose of the invisible body part, a server for storing a virtual avatar modeled in advance, and an avatar synchronization unit for encoding and transmitting the estimated full-body shape and pose for synchronization with the avatar modeled in advance in the server.

The server may include a decoding module for decoding the encoded full-body shape and pose and a mapping module for mapping the decoded full-body shape and pose to the virtual avatar.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating a system for synchronization with a virtual avatar according to an embodiment;

FIG. 2 is a block diagram illustrating an apparatus for synchronization with a virtual avatar according to an embodiment;

FIG. 3 is a block diagram illustrating the configuration of a body part detection unit of an apparatus for synchronization with a virtual avatar according to an embodiment;

FIG. 4 is a block diagram illustrating the configuration of a visible body part estimation unit of an apparatus for synchronization with a virtual avatar according to an embodiment;

FIG. 5 is a block diagram illustrating the configuration of an invisible body part generation unit of an apparatus for synchronization with a virtual avatar according to an embodiment;

FIG. 6 is a block diagram illustrating the configuration of a body estimation unit of an apparatus for synchronization with a virtual avatar according to an embodiment;

FIG. 7 is a block diagram illustrating the configuration of a server according to an embodiment;

FIG. 8 is a block diagram illustrating a method for synchronization with a virtual avatar according to an embodiment; and

FIG. 9 is a block diagram illustrating the configuration of a computer system according to an embodiment.

### DESCRIPTION OF THE PREFERRED EMBODIMENTS

The advantages and features of the present disclosure and methods of achieving the same will be apparent from the exemplary embodiments to be described below in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only, and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

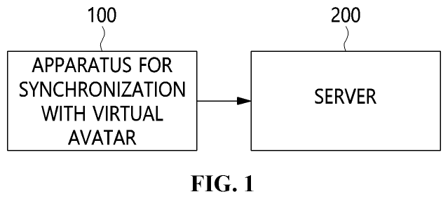

FIG. 1 is a block diagram illustrating a system for synchronization with a virtual avatar according to an embodiment.

Referring to FIG. 1, the system for synchronization with a virtual avatar according to an embodiment may include an apparatus 100 for synchronization with a virtual avatar and a server 200.

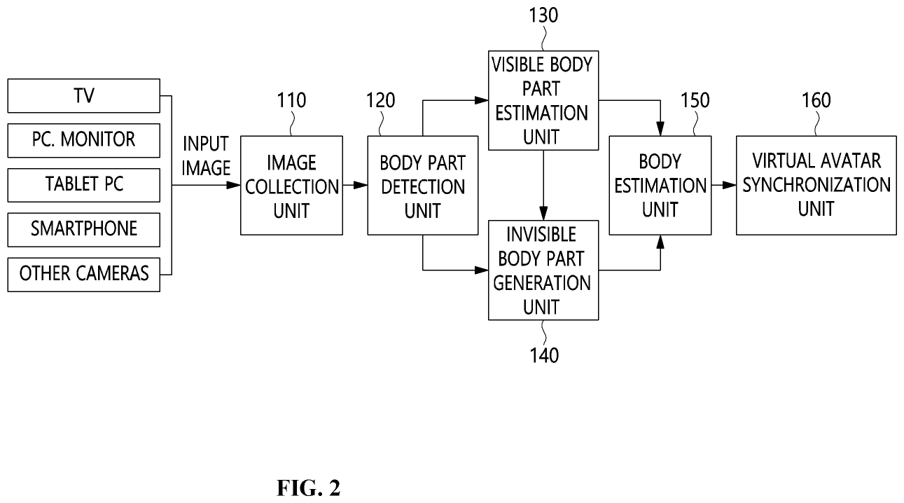

FIG. 2 is a block diagram illustrating an apparatus for synchronization with a virtual avatar according to an embodiment.

Referring to FIG. 2, the apparatus 100 for synchronization with a virtual avatar according to an embodiment may estimate and generate a body shape and pose of a user and synchronize the generated body shape and pose of the user with a virtual avatar stored in the server 200.

The apparatus 100 for synchronization with a virtual avatar may include an image collection unit 110, a body part detection unit 120, a visible body part estimation unit 130, an invisible body part generation unit 140, a body estimation unit 150, and a virtual avatar synchronization unit 160.

The image collection unit 110 may collect two-dimensional (2D) images. The 2D images may be collected from image collection devices, such as TVs, PCs, tablet PCs, smartphones, other cameras, and the like.

The body part detection unit 120 may detect human body parts in the input 2D image.

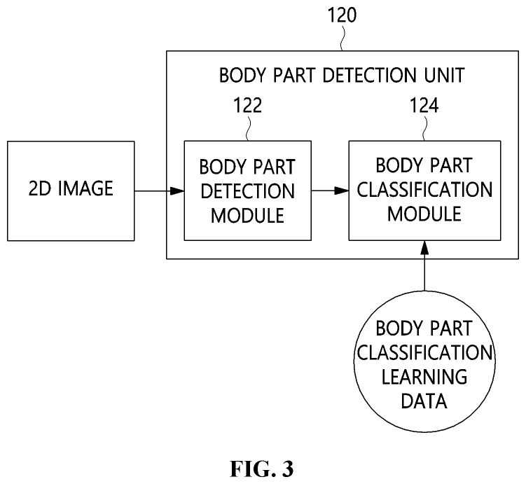

FIG. 3 is a block diagram illustrating the configuration of the body part detection unit of an apparatus for synchronization with a virtual avatar according to an embodiment.

Referring to FIG. 3, the body part detection unit 120 according to an embodiment may include a body part detection module 122 and a body part classification module 124.

The body part detection module 122 may detect a region in which a body part is located in a 2D image as a boxed region. Because a full body may not be shown in the 2D image, the probability that the joint key points of a main body part appear may be represented in the form of a heatmap based on an algorithm in the form of a deep neural network (DNN). Here, the boxed region in which a body part is located may be detected using the minimum and maximum values on x and y axes for the top, bottom, left and right, among values exceeding a specific threshold in the 2D image region.

The body part classification module 124 may identify which body part is shown in the boxed region in which the body part is located. For example, the boxed region is divided into regions, each having a size of 8×8 or 6×6, and each of the regions is learned using a neural network, whereby the body part shown in the region may be classified.

The body part classification module 124 may classify a body part region by training a convolutional neural network that is based on previously provided body part classification learning data.

Referring back to FIG. 2, the visible body part estimation unit 130 may estimate the shape and pose of a visible body part based on the body part information. Generally, the body part region that is shown may change depending on the content viewing environment. For example, a TV may show a full body, a PC may show an upper body, and a tablet PC or a smartphone may show a face. Accordingly, the body part shown depending on the environment may be estimated using the visible body part estimation unit 130.

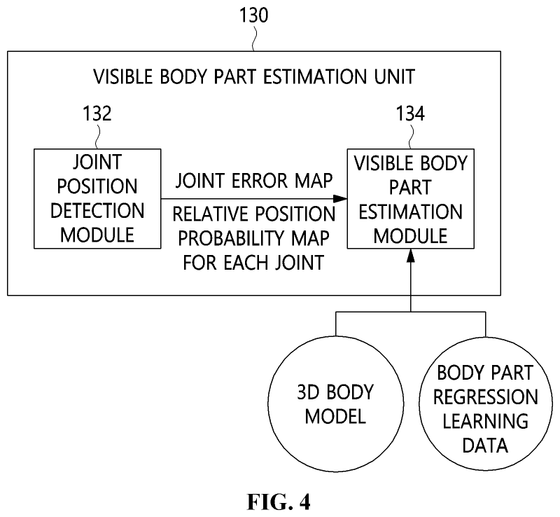

FIG. 4 is a block diagram illustrating the configuration of a visible body part estimation unit of an apparatus for synchronization with a virtual avatar according to an embodiment.

Referring to FIG. 4, the visible body part estimation unit 130 may include a joint position detection module 132 and a visible body part estimation module 134.

The joint position detection module 132 may detect the joint position of the detected body part. The joint position detection module 132 may detect the joint position using a convolutional neural network.

The joint position detection module 132 may generate a joint error map in units of pixels and a relative position probability map for each joint based on the detected joint position.

Here, the joint error map represents an error rate with regard to whether a pixel belongs to a joint. The relative position probability map for each joint represents the position difference relative to a joint that is not shown due to the angle of view as a probability.

The visible body part estimation module 134 may perform regression of a partial 3D body shape and pose of the visible joint using the joint error map and the relative position probability map for each joint.

The visible body part estimation module 134 may be implemented using an algorithm that preforms regression by projecting a skinned multi-person linear (SMPL) model to the 2D image of a visible body part using a convolutional neural network.

Referring back to FIG. 2, the invisible body part generation unit 140 may generate an invisible 3D human body shape and pose using only a partially visible body part, rather than using an image of the whole body. The invisible body part generation unit 140 may arbitrarily generate bodies that are hidden and not shown due to a narrow angle of view of a camera.

The invisible body part generation unit 140 may generate a shape and pose of an invisible body part, which are not shown, using the body part information detected by the body part detection unit 120 and the visible body part information estimated by the visible body part estimation unit 130.

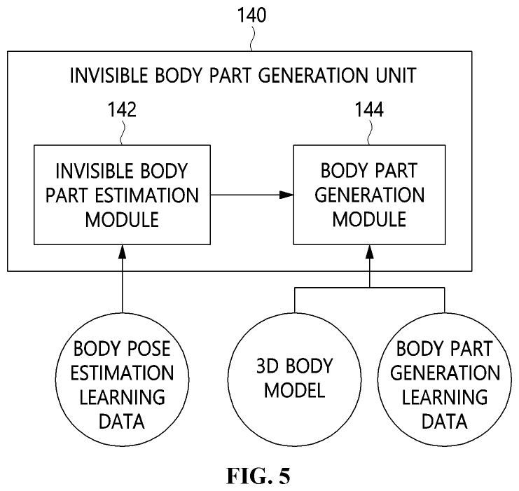

FIG. 5 is a block diagram illustrating the configuration of an invisible body part generation unit of an apparatus for synchronization with a virtual avatar according to an embodiment.

Referring to FIG. 5, the invisible body part generation unit 140 may include an invisible body part estimation module 142 and a body part generation module 144.

The invisible body part estimation module 142 may estimate an invisible body pose by learning the association between visible body shape and pose data and invisible body shape and pose data using a regression algorithm. The regression algorithm may use a convolutional neural network.

The body part generation module 144 may generate a 3D body part shape and pose based on the invisible body shape and pose data.

For example, when a user is viewing a virtual performance using a smartphone, only the face is captured by a camera, and the orientation of the face (shape) and a facial expression (pose) are estimated, after which a dance motion is applied thereto in tune with music content.

In another example, when the face of a user is hidden and not shown and only other body parts are shown while the user is viewing a virtual performance in a PC environment, various facial expressions may be generated depending on the motion of the body.

Referring back to FIG. 2, the body estimation unit 150 may estimate the body shape and pose of the full body based on the shape and pose of the visible body part and the shape and pose of the invisible body part.

The body estimation unit 150 normalizes the pose based on specific joint length information of the body and performs regression again using the SMPL model, thereby estimating a 3D human body shape and pose.

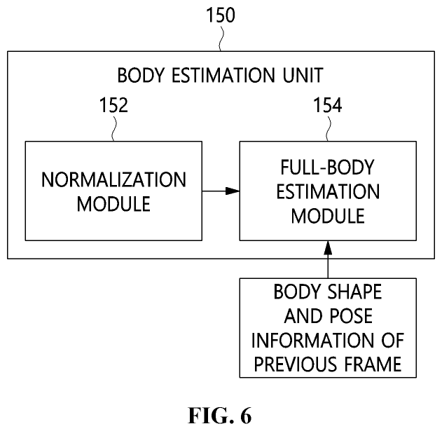

FIG. 6 is a block diagram illustrating the configuration of a body estimation unit of an apparatus for synchronization with a virtual avatar according to an embodiment.

Referring to FIG. 6, the body estimation unit 150 may include a normalization module 152 and a full-body estimation module 154.

The normalization module 152 may normalize size and orientation information pertaining to the visible body shape and pose and size and orientation information pertaining to the invisible body shape and pose.

The full-body estimation module 154 may fuse the normalized visible body part shape and pose and the normalized invisible body part shape and pose. That is, the full-body estimation module may smooth and fuse the normalized 3D human body shape and pose information in a current frame and the shape and pose information in a previous frame in order to reduce the discrepancy between successive motions. The relationship in the shape and pose between the frames may be used by training a recurrent neural network (RNN) capable of reflecting a change in motion over time.

Referring back to FIG. 2, the virtual avatar synchronization unit 160 may encode the full-body shape and pose information of a 3D body using an auto-encoder in order to synchronize the same with a virtual avatar.

The server 200 may be the space in which a preset virtual avatar is stored. The server 200 may receive the encoded full-body shape and pose information of the 3D body from the virtual avatar synchronization unit and perform synchronization with the virtual avatar.

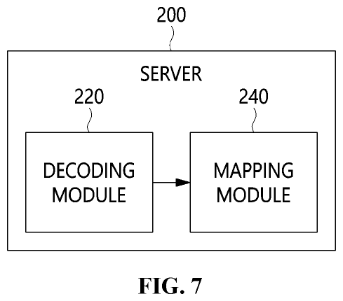

FIG. 7 is a block diagram illustrating the configuration of a server according to an embodiment.

Referring to FIG. 7, the server 200 may include a decoding module 220 and a mapping module 240.

The decoding module 220 decodes the encoded 3D full-body shape and pose information, thereby reconstructing the same.

The mapping module 240 may map the decoded 3D full-body shape and pose information to the virtual avatar.

The system for synchronization with a virtual avatar according to an embodiment may perform synchronization with the virtual avatar stored in the server using the body shape and pose of a user.

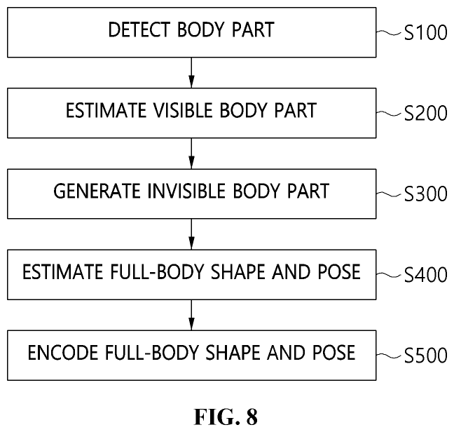

FIG. 8 is a block diagram illustrating a method for synchronization with a virtual avatar according to an embodiment.

Referring to FIG. 8, the method for synchronization with a virtual avatar according to an embodiment may be performed by an apparatus for synchronization with a virtual avatar.

The apparatus for synchronization with a virtual avatar may collect a 2D input image and detect a human body part in the input 2D image at step S100.

The apparatus for synchronization with a virtual avatar may estimate the shape and pose of a visible body part based on the detected body part at step S200.

The apparatus for synchronization with a virtual avatar may generate a shape and pose of an invisible body part based on the body part and the shape and pose of the body part at step S300.

The apparatus for synchronization with a virtual avatar may estimate a full-body shape and pose based on the shape and pose of the visible body part and the shape and pose of the invisible body part at step S400.

The apparatus for synchronization with a virtual avatar may encode and transmit the estimated full-body shape and pose information in order to perform synchronization with an avatar that is modeled in advance in the server at step S500.

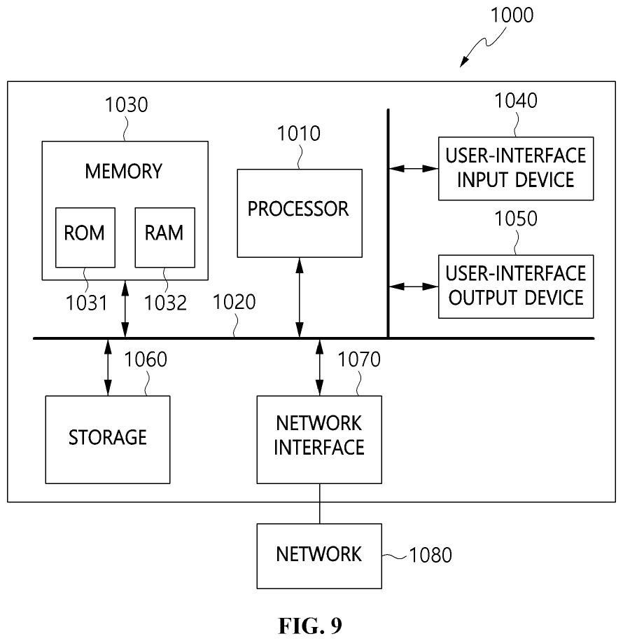

FIG. 9 is a block diagram illustrating the configuration of a computer system according to an embodiment.

Referring to FIG. 9, the computer system 1000 according to an embodiment may include one or more processors 1010, memory 1030, a user-interface input device 1040, a user-interface output device 1050, and storage 1060, which communicate with each other via a bus 1020. Also, the computer system 1000 may further include a network interface 1070 connected to a network.

The processor 1010 may be a central processing unit or a semiconductor device for executing a program or processing instructions stored in the memory or the storage. The processor 1010 is a kind of central processing unit, and may control the overall operation of the apparatus for synchronization with a virtual avatar.

The processor 1010 may include all kinds of devices capable of processing data. Here, the ‘processor’ may be, for example, a data-processing device embedded in hardware, which has a physically structured circuit in order to perform functions represented as code or instructions included in a program. Examples of the data-processing device embedded in hardware may include processing devices such as a microprocessor, a central processing unit (CPU), a processor core, a multiprocessor, an application-specific integrated circuit (ASIC), a field-programmable gate array (FPGA), and the like, but are not limited thereto.

The memory 1030 may store various kinds of data for overall operation, such as a control program, and the like, for performing a method for synchronization with a virtual avatar according to an embodiment. Specifically, the memory may store multiple applications running in the apparatus for synchronization with a virtual avatar and data and instructions for operation of the apparatus for synchronization with a virtual avatar.

The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to an embodiment, the computer-readable recording medium storing a computer program therein may contain instructions for making a processor perform a method including an operation for detecting a human body part in an input 2D image, an operation for estimating the shape and pose of a visible body part based on the detected body part, an operation for generating a shape and pose of an invisible body part based on the body part and the shape and pose of the body part, an operation for estimating a full-body shape and pose based on the shape and pose of the visible body part and the shape and pose of the invisible body part, and an operation for encoding and transmitting the estimated full-body shape and pose information in order to perform synchronization with an avatar modeled in advance in a server.

According to the present disclosure, there is an effect in which a 3D body shape and pose can be effectively generated using images collected under the condition of a narrow angle of view.

Also, the embodiment may enable effective synchronization with a virtual avatar using images collected in various viewing device environments.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. An apparatus for synchronization with a virtual avatar, comprising:
a body part detection unit for detecting a body part of a human in an input 2D image;
a visible body part estimation unit for estimating a shape and pose of a visible body part based on the detected body part;
an invisible body part generation unit for generating a shape and pose of an invisible body part based on the body part and a shape and pose of the body part;
a body estimation unit for estimating a full-body shape and pose based on the shape and pose of the visible body part and the shape and pose of the invisible body part; and
a virtual avatar synchronization unit for encoding and transmitting the estimated full-body shape and pose for synchronization with a virtual avatar that is modeled in advance in a server.

2. The apparatus of claim 1, further comprising:
an image collection unit for collecting the 2D image.

3. The apparatus of claim 1, wherein the body part detection unit includes:
a body part detection module for detecting a region in which a body is located in the 2D image as a boxed region; and
a body part classification module for classifying a body part in the boxed region.

4. The apparatus of claim 3, wherein the body part detection module predicts joint key points of a main part using a deep neural network and detects the boxed region based on the joint key points.

5. The apparatus of claim 3, wherein the body part classification module divides the boxed region into multiple regions and classifies each of the multiple regions as a body part using a convolutional neural network.

6. The apparatus of claim 1, wherein the visible body part estimation unit includes:
a joint position detection module for detecting a joint position of the detected body part; and
a visible body part estimation module for estimating a shape and pose of a 3D body part based on the detected joint position.

7. The apparatus of claim 1, wherein the invisible body part generation unit includes:
an invisible body part estimation module for estimating the shape and pose of the invisible body part based on the shape and pose of the visible body part; and
a body part generation module for generating a shape and pose of an invisible 3D body part based on the estimated shape and pose of the invisible body part.

8. The apparatus of claim 1, wherein the body estimation unit includes:
a normalization module for normalizing size and orientation information pertaining to the shape and pose of the visible body part and size and orientation information pertaining to the shape and pose of the invisible body part; and
a full-body estimation module for estimating a human full-body shape and pose by fusing the normalized shape and pose of the visible body part and the normalized shape and pose of the invisible body part.

9. The apparatus of claim 1, wherein the server includes:
a decoding module for decoding the encoded full-body shape and pose; and
a mapping module for mapping the decoded full-body shape and pose to the virtual avatar.

10. A method for synchronization with a virtual avatar, comprising:
detecting a body part of a human in an input 2D image;
estimating a shape and pose of a visible body part based on the detected body part;
generating a shape and pose of an invisible body part based on the body part and a shape and pose of the body part;
estimating a full-body shape and pose based on the shape and pose of the visible body part and the shape and pose of the invisible body part; and
encoding and transmitting the estimated full-body shape and pose for synchronization with a virtual avatar that is modeled in advance in a server.

11. The method of claim 10, further comprising:
collecting the 2D image.

12. The method of claim 10, wherein detecting the body part includes:
detecting a region in which a body is located in the 2D image as a boxed region; and
classifying a body part in the boxed region.

13. The method of claim 12, wherein detecting the region as the boxed region comprises predicting joint key points of a main part using a deep neural network and detecting the boxed region based on the joint key points.

14. The method of claim 12, wherein classifying the body part comprises dividing the boxed region into multiple regions and classifying each of the multiple regions as a body part using a convolutional neural network.

15. The method of claim 10, wherein estimating the shape and pose of the visible body part includes:
detecting a joint position of the detected body part of the human; and
estimating a shape and pose of a 3D body part based on the detected joint position.

16. The method of claim 10, wherein generating the shape and pose of the invisible body part includes:
estimating the shape and pose of the invisible body part based on the shape and pose of the body part; and
generating a shape and pose of an invisible 3D body part based on the estimated shape and pose of the invisible body part.

17. The method of claim 10, wherein estimating the full-body shape and pose includes:
normalizing size and orientation information pertaining to the shape and pose of the visible body part and size and orientation information pertaining to the shape and pose of the invisible body part; and
estimating a human full-body shape and pose by fusing the normalized shape and pose of the visible body part and the normalized shape and pose of the invisible body part.

18. The method of claim 10, wherein the server decodes the encoded full-body shape and pose and maps the decoded full-body shape and pose to the virtual avatar.

19. A system for synchronization with a virtual avatar, comprising:
a body part detection unit for detecting a body part of a human in an input 2D image;
a visible body part estimation unit for estimating a shape and pose of a visible body part based on the detected body part;
an invisible body part generation unit for generating a shape and pose of an invisible body part based on the body part and a shape and pose of the body part;
a body estimation unit for estimating a full-body shape and pose based on the shape and pose of the visible body part and the shape and pose of the invisible body part;
a server for storing a virtual avatar modeled in advance; and
an avatar synchronization unit for encoding and transmitting the estimated full-body shape and pose for synchronization with the avatar modeled in advance in the server.

20. The system of claim 19, wherein the server includes:
a decoding module for decoding the encoded full-body shape and pose; and
a mapping module for mapping the decoded full-body shape and pose to the virtual avatar.
